(19) United States
(12) Patent Application Publication
(10) Pub. No.: US 2018/0237094 A1
(43) Pub. Date: Aug. 23, 2018

(54) MODULAR MOTOR SCOOTER

(71) Applicant: INNOVATIVE DRAGON LTD., London (GB)

(72) Inventor: Herwig FISCHER, London (GB)

(21) Appl. No.: 15/745,503

(22) PCT Filed: Jul. 6, 2016
(86) PCT No.: PCT/EP2016/065923

§ 371 Date: May 11, 2018

(30) Foreign Application Priority Data
Jul. 18, 2015 (DE) 10 2015 009 428.9

(51) Int. Cl. B62K 5/027; B62J 17/08; B62J 27/00; B62J 1/28; B62K 5/05; B62K 5/08; B62K 5/10; B62K 5/06

(52) U.S. Cl. CPC B62K 5/027; B62J 17/08; B62J 27/00; B62J 1/28; B62J 1/12; B62K 5/08; B62K 5/10; B62K 5/06; B62J 2017/086; B62K 5/05

(57) ABSTRACT

A motor scooter, for transportation of one person or multiple persons, includes a motoric drive. To provide a safe and comfortable motor scooter, which is environmentally-friendly, suitable for everyday-life and cost-effective, the motor scooter is connectable with various modules in a releasable manner. As such the motor scooter can include various and selectable module combinations.

### CROSS REFERENCE TO RELATED APPLICATIONS

This application is a United States National Phase Application of International Application PCT/EP2016/065923, filed Jul. 6, 2016, and claims the benefit of priority under 35 U.S.C. § 119 of German Application 10 2015 009 428.9 filed Jul. 18, 2015, the entire contents of which are incorporated herein by reference.

### FIELD OF THE INVENTION

The present invention relates to a motor scooter for the transport of one or more persons, the motor roller comprising a motoric drive.

### BACKGROUND OF THE INVENTION

Motor scooters are road vehicles with numerous advantages such as high flexibility, a minimum occupancy of traffic areas, both in the driven and parked state, low energy consumption, and low emissions. These scooters are mostly driven by users looking for a cost-effective alternative to a car and/or users not yet having a driver's license for a car. In most cases however, users tend to use a car after a while, and the motor scooter is no longer used.

With an increasing road traffic in large cities, the motor scooter is an alternative with true advantages, because the user—although in a non-reliable manner—can not only circumvent passenger cars that are stuck in a traffic jam, but also because as a result thereof, the flow of traffic is improved, and the loss time caused by traffic jams is reduced for all road users.

Despite these obvious advantages, the common use of motor rollers is comparatively small. One of the causes is that motor scooters involve a considerable loss of comfort while driving. For one, there is a need to wear a helmet for safety reasons, and preferably also a motorcycle suit having integrated protective elements, so that heat builds up in the summer season. The major part of users considers a helmet to be uncomfortable, and it affects a user's hairstyle in such a way that the appearance of the user is tarnished at the destination. For the active part of the population, the use of a motor scooter only hardly is a suitable alternative. On the other hand, the user is totally unprotected against rain and cold temperatures during winter and bad weather conditions. To sum up, the disadvantages of a motor scooter outweigh those of a passenger car and its potential advantages remain unused.

### SUMMARY OF THE INVENTION

It is therefore an object of the present invention to provide a safe and comfortable motor scooter, which is environmentally-friendly, suitable for everyday-life and cost-effective.

This object is achieved by a motor scooter according to the invention, which, according to the invention, can be connected to different modules in a releasable manner, so that the motor scooter can comprise various and selectable module combinations. In particular, the modules can be bought individually, which is why not all of these modules must be selected and purchased when purchasing a new motor scooter according to the invention.

According to a first preferred embodiment of the invention, it is provided that a first module is a backrest, which can be connected releasably to the motor scooter (in a releasable manner) and which preferably comprises a seat-belt system, by means of which the driver or co-driver can fasten himself/herself to the backrest. The backrest, in the installed state, preferably protrudes in the height direction and laterally beyond a person wearing a seat belt, such that in the case of a spill or accident, the person wearing the seat-belt does not collide with the road surface or any other obstacle. To that end, the backrest has a preferred minimum width of 0.6 m and/or a preferred minimum height of 0.8 m above the seating surface of the motor scooter.

The backrest and/or a main body (chassis) of the motor scooter can be produced from various materials, wherein composite materials, in particular fiber composite materials, are particularly preferred here. In particular, the main body can be a sandwich-type structure of carbon fibers with integrated fix points for mounting add-on parts, in particular for the mounting of one of the modules.

According to a further preferred embodiment of the invention, it is provided that the backrest is fixed at the main body of the motor scooter in such a way, that the backrest is rigid in the driving direction and counter-driving direction and is adapted to receive high loads, wherein the backrest is preferably flexible in the lateral direction and can be tilted to the right and to the left within a limited angle, in order to allow the driver (and co-driver) to “lean into the corner”. Incidentally, elastic elements support the inclination of the backrest.

Preferably, at least one Airbag is arranged in the belt system and/or the backrest and/or the inner area on the front surface of the access.

Preferably, the backrest can be connected to the motor scooter in at least two positions spaced from one another, i.e. a front position and a rear position, wherein the backrest can preferably be continuously secured between these positions.

Besides the backrest as a first module, the motor scooter can be connected to a second module. According to a preferred embodiment of the invention, a second module is a windshield, which, on the one side, is connected to the motor scooter and, on the other side, with the backrest in a releasable manner, wherein the front connection is preferably arranged in front of the handlebar and/or laterally next to the access on the main body of the motor scooter. This windshield is in part formed as a roof surface or can be connected to a separate roof surface, preferably in a releasable manner. The unit of windshield and backrest is configured in such a way that the windshield and the backrest form a roll cage.

The configuration of the motor scooter with a backrest as a first module and a windshield as second module describes a motor scooter that can be used in a safe, ecological and comfortable manner, that can be driven by a male or a female driver in casual clothes, business clothes, that can be driven both in a suit or in a coat-and-skirt, without being impaired by a helmet, rain, moisture, or other protective suits. This results in a new target group for this scooter, finding a real alternative to a passenger car.

Besides the normal two-wheeler with front and rear wheels, suspension, handlebar, brakes, drive and seat bench, further modules are provided, in particular the backrest with an integrated over-roll protection and a front glazing as a front and top rain protection.

The backrest, in particular if produced from a fiber composite material, is very stable and protrudes beyond the front outline of the driver laterally and at the top at in each case at least one location, such that in case of an accident, this support, not the driver, contacts the ground. The driver is diagonally-seat-belted to this backrest by means of one or multiple belts, in such a way, that he or she is fixed to this rest and remains safe in the case of a collision with an obstacle or with the road surface. In case the motor scooter experiences a roll-over, the rest protruding upwards will absorb the impact energy and protect the driver's head, so that no helmet must be worn. The belt system preferably consists of two diagonally-guided belts with automatic reeling, wherein preferably one of the belts also comprises a transversely-guided strand as a ventral belt, such that the driver is symmetrically protected against an impact from the sides. Similar to a passenger car, an elastic thickening is provided in the rest, that prevents the known whiplash effect in an impact, that often times leads to a trauma.

In contrast to conventional rollover protection cages in motor scooters, which form an integral part of the main body (chassis), the provided backrest achieves the same protective effect without having to carry along the heavy cage all the times, which cage obstructs the front view because of the front struts and lift the center of mass of the machine, which negatively affects the driving comfort. In addition, the rest can be mounted or demounted depending on the use. Furthermore, the scooter can be driven with two persons, because the backrest comes with the option to longitudinally displace the backrest. In this case, the person in the rear (co-driver) wears a seatbelt and the person in the front must wear a helmet.

The back module or backrest is formed in such a way that it can receive all loads as a pure bending support and does not have to be supported towards the front as a cage, so that the front view remains completely unobstructed. The upper end of the backrest thus provides a stable fixing point, at which the windshield is supported. The windshield is fixed to the front region of the scooter and spans all the way to the rear end of the backrest and thereby surrounds the handlebar and the driver and, if present, the co-driver seated behind the driver on the seat bench. Since the fixing mechanism is attached to two dimensionally-stable regions from one end of the windshield to the other, the pane can be formed as a pure sheet of carbonate or composite glass in such a way that the front view is not obstructed for a driver.

The backrest is fixed to the main body of the motor scooter and is demountable, so that the motor roller can also be driven the classic way without backrest. In this case, most countries have the requirement of wearing a helmet when driving a motor scooter. Furthermore, the backrest can be fixed in two different positions, namely further in the front for the case in which the driver drives on his own, and further in the back for shielding the co-driver. In this case, the co-driver is fastened and does not have to wear a head protection. The driver must wear a helmet then. Fixing of the backrest is usually possible without tools in a few steps, so that even a boarding co-driver can be accommodated on a tour in a quick and simple manner by a quick re-arrangement.

According to a preferred embodiment, a front fork is a third module, which is connected with the motor scooter in a releasable manner. The front fork is preferably configured as a suspension fork having one single front wheel. As an alternative, the front fork comprises two front wheels arranged in parallel and connected to one another through a parallelogram guiding mechanism in such a way, that the front wheels are tilted together with the chassis of the motor scooter when taking a corner. This construction allows an enhanced driving stability in corners. In addition, the scooter can be protected against tilting during stops, e.g. at a traffic light, such that the user does not have to support himself against tilting with the leg on the ground.

Preferably, the front fork having two front wheels arranged in parallel comprises at least two suspension elements in the form of two telescopes, in each case connected to one of the front wheels.

The telescopes further comprise cylinder arms connected to one another hydraulically or pneumatically, such that the paths and/or forces of the two wheels are equal in opposite directions in the tilted state of the motor scooter or when taking a corner. In other words, the telescopes are multi-coaxially positioned and/or side-by-side positioned or successively-positioned hydraulic or pneumatic cylinders, wherein a connection of the cylinder chamber from the right fork to the left fork or from the right telescope to the left telescope ensures that upon tilting, the axial movement length of the one wheel is just as long as that of the other wheel, but directed in opposite direction. As a result, it is achieved that both wheels are in parallel contact with the road surface independently of the tilt angle.

In addition to the described telescopes for lateral inclination, telescopic cylinders are arranged here coaxially and/or in parallel, which deflect and absorb independently from one another, in order to be able to compensate road irregularities on each of the wheels independently from one another.

The hydraulic or pneumatic connection between the telescopes can preferably be disconnected by means of a valve, so that the tilting capability of the motor scooter can be arrested. Similarly, the telescopic cylinders have valves, so that the damping of the telescopic cylinders can be arrested as well.

The wheels are preferably mounted in a pivotable manner to perform a steering movement, which is why the telescopes are mounted rotatably along the telescopic axles thereof.

According to a preferred embodiment of the invention, the motor scooter finally has an electro-motoric drive and, as a fourth module, a battery, which is preferably of flat configuration and which preferably is arranged at least partially below the access surface of the main body of the motor scooter. To that end, the scooter is wider on the lower side, so that enough space exists below the access for the flat batteries. This arrangement achieves that the center of mass is located low and that the mass inertia moments with respect to the support axle of the wheels on the road surface become minimal.

As a whole, the motor scooter is of modular structure in such a way, that in the same motor scooter, the front fork having only one wheel can be replaced by a fork having two front wheels and a parallel guiding mechanism. The customer can therefore first buy the scooter with only one front wheel and no backrest and/or front windshield, and can in the later term successively extend it by purchasing further modules. The same is true for the battery, which can also be integrated with different sizes and different capacities.

In a further variant, an airbag system is integrated in the belt and/or the backrest module and/or the front structure of the motor scooter, protecting and stabilizing the driver, in particular his or her head, in the case of an impact. The airbag system is triggered by acceleration sensors and/or wheel sensors.

Specific embodiments of the present invention are explained below by means of the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view showing a motor scooter having different modules;

FIG. 2 is another schematic perspective view showing the motor scooter having different modules;

FIG. 3 is another schematic perspective view showing the motor scooter having different modules;

FIG. 4 is another schematic perspective view showing the motor scooter having different modules;

FIG. 5 is another schematic perspective view showing the motor scooter having different modules;

FIG. 6 is another schematic perspective view showing the motor scooter having different modules;

FIG. 7 is a schematic perspective view showing a front fork with two front wheels arranged on it; and

FIG. 8 is a schematic view showing the front fork with two front wheels arranged on the fork.

### DESCRIPTION OF THE PREFERRED EMBODIMENTS

Referring to the drawings, FIG. 1 shows a motor scooter 1 of the type according to the invention, which can be connected to various modules. These modules particularly include a backrest as a first module, a windshield as a second module, a front fork as a third module, and a battery as the fourth module. Not all of the modules are illustrated in FIG. 1 and are in part explained in greater detail with reference to other Figures.

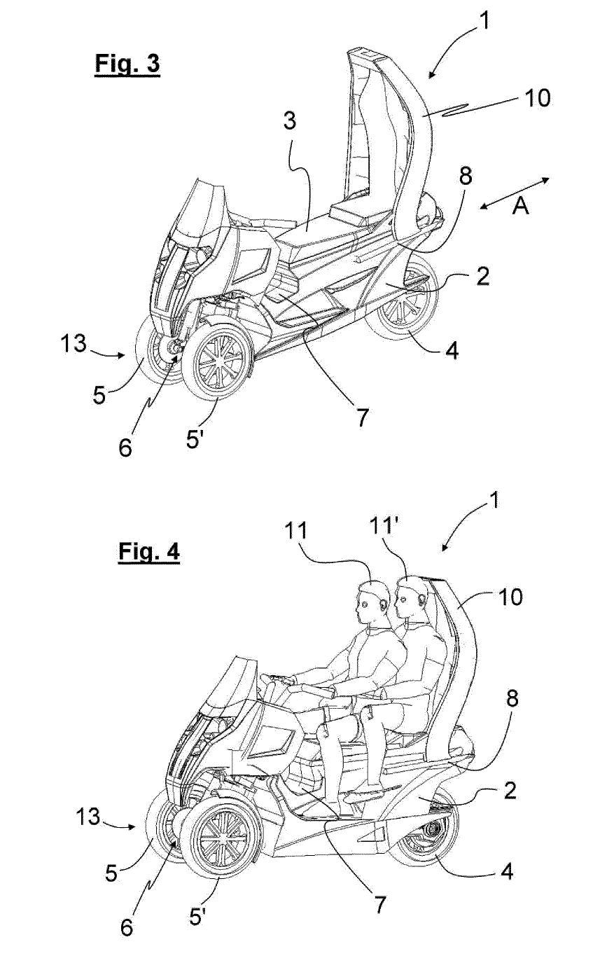

The motor scooter 1 has a main body 2 (chassis) and a seating surface 3, which configured for two persons maximum. Besides a rear wheel 4, the front side of the motor scooter 1 has a front fork 13 (third module) with two parallel front wheels 5, 5′ arranged thereon, which are connected to one another by means of a parallelogram guiding mechanism 6. As an alternative, the front fork 13 with two parallel front wheels 5, 5′ can be replaced with a front fork 13 with a single front wheel. In order to allow a more comfortable access, the motor scooter 1 comprises a step-through surface 7, under which a (not illustrated) battery (fourth module) is arranged in one embodiment of the motor scooter 1 as an electric scooter. Guide rails 8 are provided next to the main body 2, which serve for fastening a backrest (first module), which will be explained in greater detail with reference to FIG. 3.

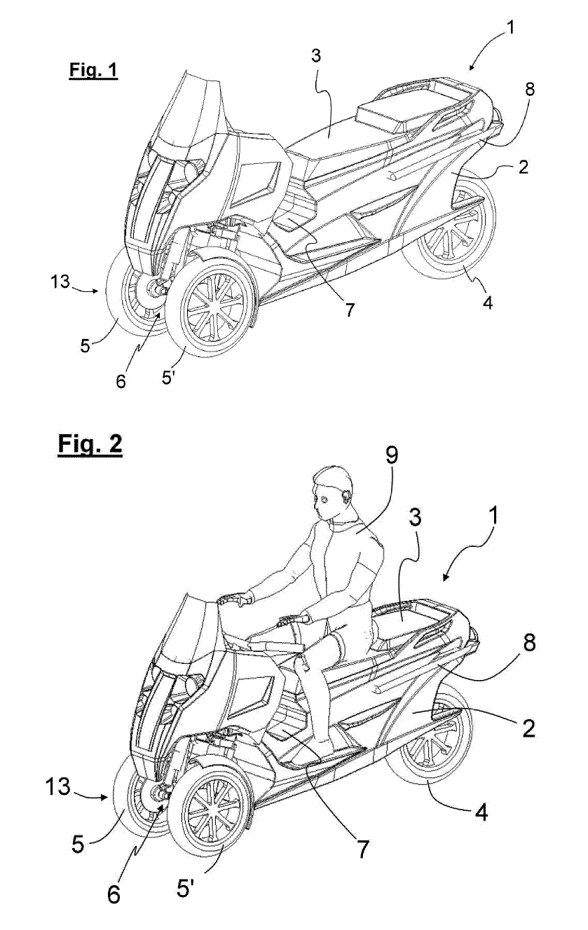

FIG. 2 shows the motor scooter 1 of FIG. 1 with a person 9 seated there.

FIG. 3 illustrates the motor scooter 1 with a backrest 10 (first module), which is fixed on the guide rail 8 laterally next to the main body 2 in a manner to be displaceable in the direction of arrow A. The displaceability of the backrest 10 in the arrow direction A allows the use of the backrest 10 for the driver or for the co-driver. In the rear position illustrated in FIG. 3, the backrest 10 serves for a co-driver, which is shown in FIG. 4. Here, the motor scooter 1 is used by a driver 11 and a co-driver 11′, who uses the back support 10 as a backrest and for strapping-in by means of a belt system (not shown).

FIG. 5 shows another module that can be connected to the motor scooter 1, where the motor scooter 1, in addition to a backrest 10, also comprises a windshield 12 which is connected to the motor scooter 1 in front of the handlebar on the front side, and connected to the backrest 10 at the rear side. The windshield 12 not only serves as a windshield and as protection against rain, but it forms a roll cage together with the backrest 10, which protects the driver and co-driver 11′ in the case of an accident.

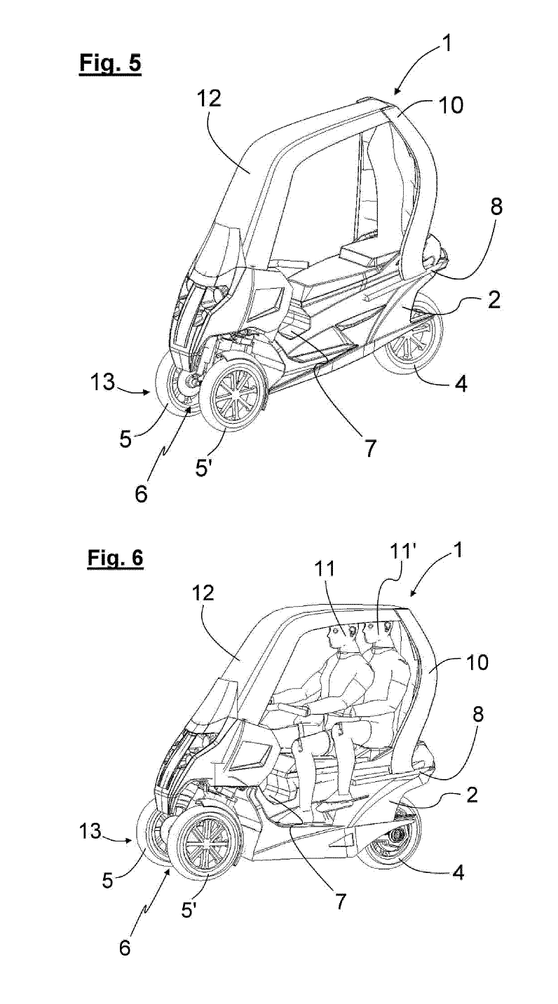

FIG. 6 finally shows an embodiment of the motor scooter 1 in which the motor scooter is used by a driver 11 and a co-driver 11′, wherein the motor scooter 1 has both a windshield 12 and a backrest 10.

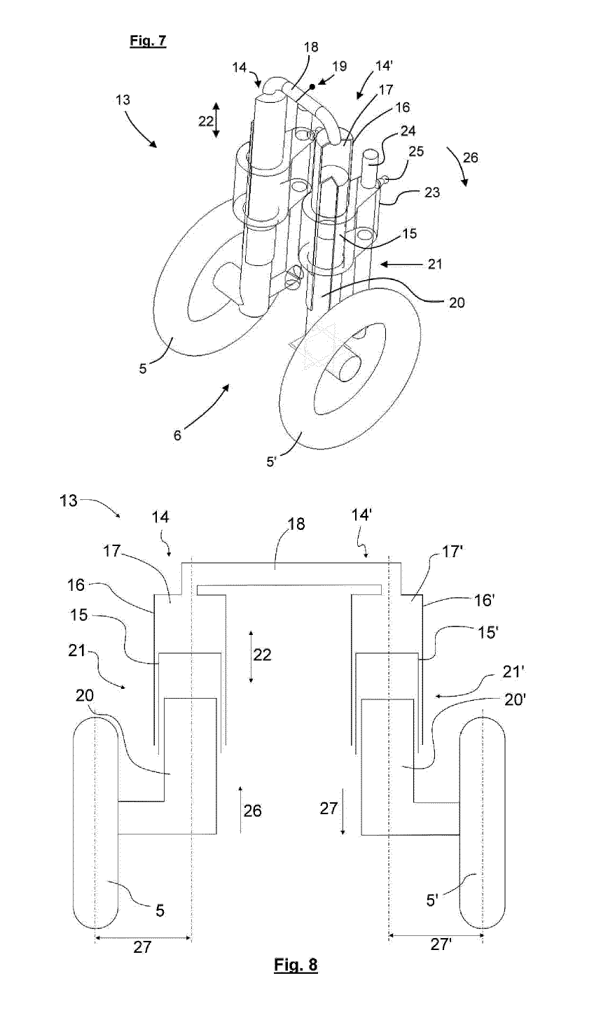

The already-described front fork 13, as the third module, with a parallelogram guiding mechanism 6 is illustrated in detail in FIG. 7. The front fork 13 essentially has two telescopes 14, 14′ in each case connected to a front wheel 5, 5′. In order to allow the motor scooter 1 to tilt when taking a corner, with both wheels 5, 5′ in parallel contact with the road surface, the telescopes 14, 14′ each comprise one hollow cylinder 15, 15′, which can be displaced axially in the longitudinal direction inside an outer cylinder arm 16 16′ (main cylinder) and which forms a first cylinder chamber 17, 17′ inside the cylinder arm 16, 16′. The first cylinder chambers 17, 17′ of the telescopes 14, 14′ are interconnected via a hydraulic bridge 18, which is why lowering of a wheel 5, 5′ immediately causes a lifting of the wheel 5, 5′ and vice versa. The hydraulic bridge (mechanism) 18 is closeable by means of a valve 19, so that the tilting mechanism can be arrested at a complete stop of the motor scooter 1 or at complete stop at a traffic light.

In order to compensate unilateral shocks, the wheels 5, 5′ are supported inside the hollow cylinder 15 by means of another piston 20, containing a pneumatic suspension and/or spring suspension. The piston 20 and the hollow cylinder 15 together form the telescopic cylinder 21 moveably supported inside the cylinder arm 16 in the direction of arrow 22. If road surface irregularities occur, the individual wheels 5, 5′ are therefore mounted in a spring-loaded manner independently of one another here.

The individual suspension of the wheels 5, 5′ can also be arrested by means of valves on the telescopes 14, 14′, respectively on the telescopic cylinders 21, 21′.

FIG. 8 once more clarifies the structure of the front fork 13 with two wheels 5, 5′ in a cross-sectional illustration. The front fork 13, on the left and right sides, has in each case one telescope 14, 14′ which forms the wheel suspension. The telescopes 14, 14′ first of all each comprise a cylinder arm 16, 16′ having a telescopic cylinder 21, 21′ movably mounted in the arrow direction 22, and which consists per se of a hollow cylinder 15, 15′ and a piston 20, 20′. To provide an operational tilting technology, the telescopic cylinders 21, 21′ and the cylinder arms 16, 16′ have cylinder chambers 17, 17′ formed therebetween and interconnected hydraulically by means of a bridge mechanism 18, as the volume of the bridge 18 and of the cylinder chambers 17, 17′ remains constant, the lift of the wheel 5 in arrow direction 26 will cause a lowering of the wheel 5′ in arrow direction 27 and vice versa.

In case of a unilateral shock, suspension of the wheels 5, 5′ is implemented by the telescopic cylinders 21, 21′. The telescopic cylinders 21, 21′ consist of the respective outer hollow cylinders 15, 15′ and inner pistons 20, 20′, which have a damping of an arbitrary type, e.g. pneumatic or by means of a spring, arranged therebetween. Both the tilting technique and the damping can be arrested by means of valves (not illustrated in FIG. 8).

In a steering operation of a motor scooter 1 having a front fork 13 according to FIG. 7, pivotability of the wheels 5, 5′ is required despite the fact that the tilting mechanism is provided. To that end, cylinder arms 16, 16′ are engaged around by sleeves 23, 23′, which are connected with in each case one thrust rod 24 in an axially spaced manner, which are moveable axially with respect to the rod both when tilting and in a unilateral damping. Furthermore, each sleeve 23, 23′ has a ball head 25 for the connection of the steering (not illustrated), so that pivoting of the sleeves 23, 23′ in the arrow direction 26 causes a rotation/pivoting of the wheels 5, 5′ and also a steering angle.

In the exemplary embodiment illustrated in FIG. 8, the telescopes 14, 14′ are oriented in parallel and (in the case of the motor scooter not tilted) vertical to the support planes of wheels 5, 5′. This results in a comparatively large steering/wheel radius 27, 27′. In an alternative embodiment, with the geometry of front fork 13 unchanged, telescopes 14, 14′ can be inclined relative to the support planes, so that a significantly smaller or even negative steering/wheel radius 27, 27′ results, which has a positive effect on the steering behavior.

While specific embodiments of the invention have been shown and described in detail to illustrate the application of the principles of the invention, it will be understood that the invention may be embodied otherwise without departing from such principles.

1. A motor scooter for transporting one or more person(s), the motor scooter comprising:
a motor scooter main body;
different modules; and
a motoric drive connected to the motor scooter main body, wherein the motor scooter main body is connectable to any of one or more of the different modules releasably, such that the motor scooter can comprise various and selectable module combinations.

2. The motor scooter according to claim 1, wherein a first module of the different modules is a backrest, which is connectable to the motor scooter releasably and which comprises a belt system, by means of which a driver or co-driver is fastenable to the backrest.

3. The motor scooter according to claim 2, wherein the backrest protrudes in the height direction and laterally beyond a person wearing a seat belt of the belt system, such that in case of a spill or accident, the person wearing the seat-belt does not hit the road surface or any other obstacle.

4. The motor scooter according to claim 3, wherein the backrest has a width of at least 0.6 m and/or a height of 0.8 m above the seating surface.

5. The motor scooter according to claim 2, wherein the backrests and/or the main body of the motor scooter consist of fiber composite materials.

6. The motor scooter according to claim 1, wherein the main body is a sandwich structure of carbon fibers with integrated fixing points for mounting one of the modules.

7. The motor scooter according to claim 2, wherein the backrest is fixed at the main body such that the backrest is rigid in the driving direction and opposite the driving direction and is adapted to receive high loads, wherein the backrest is flexible in the lateral direction to allow the driver to lean into a corner.

8. The motor scooter according to claim 2, wherein an inclination of the backrest is supported via elastic elements.

9. The motor scooter according to claim 2, further comprising at least one airbag arranged in the belt system and/or arranged in the backrest and/or arranged in an inner area on a front surface of an access region.

10. The motor scooter according to claim 2, wherein the backrest connectable to the motor scooter main body in at least two positions, spaced from one another, comprising a front position and a rear position, wherein the backrest is continuously fixable between the front and rear positions.

11. The motor scooter according to claim 2, wherein a second module of the different modules is a windshield, which, on one side thereof, is connected, by a front connection to the motor scooter main body and, on another side of the windshield, is connected to the backrest releasably, wherein the front connection is arranged in front of a handlebar and/or laterally next to an access region on the motor scooter main body.

12. The motor scooter according to claim 11, wherein the windshield is in part configured as a roof surface or is connectable to a separate roof surface, releasably.

13. The motor scooter according to claim 11, wherein the windshield and the backrest form an over-roll cage.

14. The motor scooter according to claim 11, wherein a third module of the different modules is a front fork, which is connectable to the motor scooter main body releasably.

15. The motor scooter according to claim 14, wherein the front fork is formed as a spring fork with one single front wheel.

16. The motor scooter according to claim 14, wherein the front fork comprises a parallelogram guiding mechanism and two front wheels arranged in parallel, which two front wheels are connected to one another through the parallelogram guiding mechanism such that the front wheels are tilted when taking a corner.

17. The motor scooter according to claim 16, wherein the front fork, with two front wheels arranged in parallel, comprises at least two spring elements comprising two telescopes which are each connected to one of the front wheels.

18. The motor scooter according to claim 17, wherein the telescopes comprise cylinder arms connected to one another hydraulically or pneumatically, such that paths and/or forces of the two wheels are equal in opposite directions in the tilted state of the motor scooter or when taking a corner.

19. The motor scooter according to claim 18, wherein in addition to the telescopic cylinders for lateral inclination, pistons are arranged coaxially or in parallel, which deflect and absorb independently from one another, in such a way that road irregularities can be compensated.

20. The motor scooter according to claim 18, wherein a hydraulic or pneumatic connection between the telescopes is diconnectable by means of a valve, so that a tilting capability of the motor scooter can be arrested.

21. The motor scooter according to claim 18, wherein the telescopic cylinders have valves, so that the damping of the telescopic cylinders can be arrested.

22. The motor scooter according to claim 17, wherein the telescopes are mounted to be rotatable around a longitudinal axis thereof, so that a longitudinal movement of the wheels can be performed through a rotation of the telescopes.

23. The motor scooter according to claim 1, wherein the motoric drive comprises an electro-motoric drive and a module of the different modules, has a battery, which has a flat configuration and which is arranged at least partially below an access surface of the motor scooter main body.
